(19) United States
(12) Patent Application Publication
(10) Pub. No.: US 2018/0005213 A1
(43) Pub. Date: Jan. 4, 2018

(54) THE AUTOMATED SALESMAN MACHINE (ASM)/AUTOMATED ELECTRONIC TROLLEY (AET)

(71) Applicant: Kojo Benjamin Dickson Quartey, Tema (GH)

(72) Inventor: Kojo Benjamin Dickson Quartey, Tema (GH)

(21) Appl. No.: 15/542,929

(22) PCT Filed: Jan. 14, 2016
(86) PCT No.: PCT/IB2016/050173

§ 371 Date: Jul. 11, 2017

Related U.S. Application Data
(60) Provisional application No. 62/237,900, filed on Oct. 6, 2015.

(30) Foreign Application Priority Data
Feb. 23, 2015 (GH) GH/AP/D2015000001
Mar. 2, 2015 (EP) AP/D/2015/000960

(51) Int. Cl. G06Q 20/20; G07G 3/00; G07F 19/00; G07F 7/08; G06Q 30/06; B62B 3/14; G06Q 20/40; B62B 5/04; G07G 5/00; G07C 9/00; G06Q 20/34

(52) U.S. Cl. CPC G06Q 20/208; G07G 5/00; G07G 3/003; G07F 19/203; G07F 7/088; G07C 9/00896; G06Q 30/0643; B62B 3/1424; G06Q 20/40; G06Q 20/209; G06Q 20/204; B62B 5/0423; B62B 3/146; G06Q 20/34

(57) ABSTRACT

A method or a system, automatically and electronically ensures that customer pays for all goods picked up and the customer takes out of the shop only goods paid for. All this is done without the need of a shop teller and finally without the need of a shop supervisor to periodically crosscheck and ensure that the total amount of money collected by the shop teller (within a period) equals the total value of goods disbursed. The resultant of this system are the shop runs can run a totally cashless shop; reduce human resource by a significant percentage; shop can be opened 24/7; no more queues at shop teller points even during peak periods or major sales.

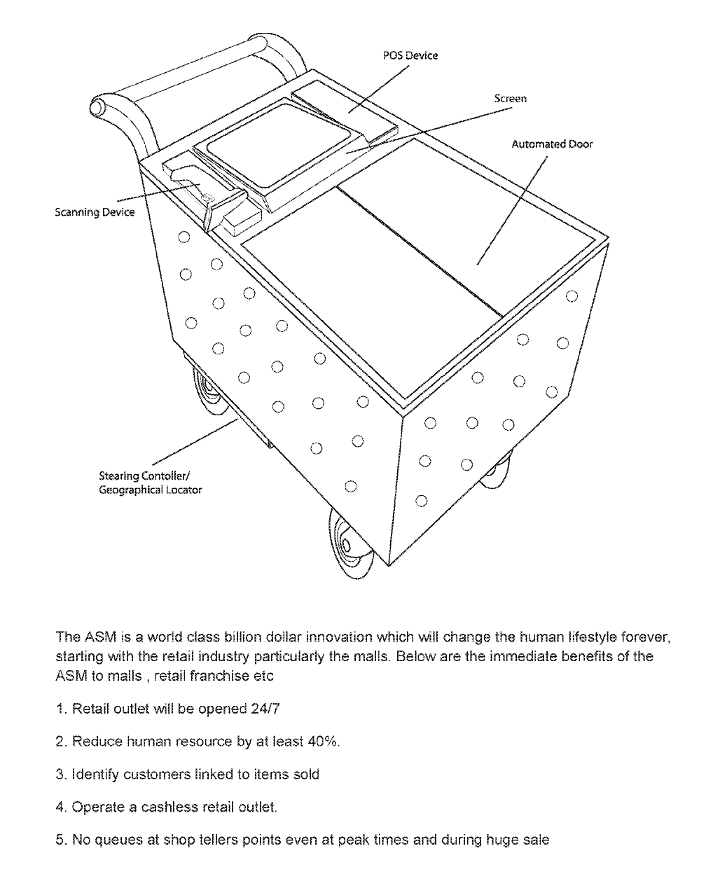

### RELATED APPLICATIONS

The present application claims the benefit of PCT/IB2016/050173, which was filed on Jan. 14, 2016, the contents of which are hereby incorporated by reference as though fully set forth herein.

### DETAILED DESCRIPTION OF PREFERRED EMBODIMENTS

The ASM is a world class billion dollar innovation which will change the human lifestyle forever, starting with the retail industry particularly the malls.

In the 1960s the banking industry took automation to a new level by the introduction of the “hole-in-a-wall” also known as Automated Teller Machines (ATMs). For the first time in the human race money could be exchanged without the physical presence of human beings for both parties. Today, very few banks can exist without the ATMs and its chain of value-added services.

The retail industry till date needs the physical presence of both parties (customer and shop teller) to ensure goods picked are all paid for and vice-versa, finally the shop supervisor must at the end of a period cross-check to ensure that the total amount of money collected by the shop teller (within a period) equals the total value of goods disbursed.

The Automated Salesman Machine or the Automated electronic Trolley, automatically and electronically ensures that customer pays for all goods picked up and the customer takes out of the shop only goods paid for. All this is done without the need of a shop teller and finally without the need of a shop supervisor to periodically cross-check and ensure that the total amount of money collected by the shop teller (within a period) equals the total value of goods disbursed.

Below are the immediate benefits of the ASM to malls, retail franchise etc

1. Retail outlet will be opened 24/7

2. Reduce human resource by at least 40%.

3. Identify customers linked to items sold

4. Operate a cashless retail outlet.

5. No queues at shop tellers points even at peak times and during huge sale

Major Components of ASM
The app
Control board
   Scanner/camera
   Display screen(tablet)
   Usb connector(s)
   POS device
   Speaker
   Text to sound converter
   Receipt printer
A well secured trolley.
   Thick glass fitted all around the trolley (with holes for ventilation)
   Automated cover or door on top on the trolley
   An electrical scale in the bottom (base) on the trolley
   Supermarket trolley

View of the Automated Salesman Machine (ASM).

Methods of Payment

1. Cards (Debit/Credit)

2. Any electronic voucher

ASM at Work (Process flow)

1. Customer Pickups the ASM

2. Customer is Shopping with ASM

3. After shopping with ASM

Customer Pickups the ASM
Customer walks into the shopping hall.
Customer pickups up an ASM.
Customer inserts ATM card/customized card into the embedded POS of the ASM or inputs the cash voucher.
Customer is asked to key in the secret card code to activate ASM and also a balance enquiry is done to ensure customer has money to spend.
When customer crosses the free zone area (can be demarked by special floor marks or lines), the ASM's cover or door closes.
The app activates the voice prompt and a pictorial diagram of the shopping hall indicating areas to locate items by categories is displayed on the embedded tablet.

Customer is Shopping with ASM
Customer moves through the shopping floor
Customer locates an item of interest
Customer Focuses on the barcode of the product
Taps the screen or ok.
The client connects to the stores database and pulls the allowed displayable information including dynamic information and product review like the online reviews.
The customer can either reject or add the product to the shopped items.
At any point during the shopping customer sees the list of items in the ASM with total cost.

After shopping with ASM
Customer can manually close till by selecting the close till button.
The receipt is displayed with items, it's quantities, cost and total cost.
Customer can accept or reject this bill.
If customer accepts the bill, there is a prompt to key in the cards secret code to enable the card to be debited.
Voice prompts asks the customer to remove card.
The bill is automatically printed (or/and emailed to customer).

Benefits to a Partner Bank
High level Corporate strategy to enter into a highly developed country
Continuous, consistent guaranteed deposit flow

### SUMMARY

The Automated Electronic Trolley (AET) is a redesigned highly secured supermarket trolley with these components a Point of sale terminal device, scanning device, printer, display screen, control board, automated reinforced door, electronic scale at the base and POS application client.

AET is the world's first fully automated self-service machine which will allow customers shop in malls and buy for goods without a shop teller to ensure that items picked are paid for

AET will give malls and large supermarkets the following benefits

1. Opened 24/7

2. Reduce human resource by at least 40%.

3. Identify customers linked to items sold

4. Operate a cashless retail outlet.

5. No queues at shop tellers points even at peak times and during huge sale

1. A system, automatically and electronically ensures that customer pays for all goods picked up and the customer takes out of the shop only goods paid for. All this is done without the need of a shop teller and finally without the need of a shop supervisor to periodically cross-check and ensure that the total amount of money collected by the shop teller (within a period) equals the total value of goods disbursed.
The resultant of this system are the shop runs can run a totally cashless shop; reduce human resource by a significant percentage; shop can be opened 24/7; no more queues at shop teller points even during peak periods or major sales.

2. The system according to claim 1, consist of 3 major components software application (7), control board (8) and an enhanced supermarket trolley (9).

3. The system according to claim 1 uses a software application which is a client point of sale application of shop, with major enhancements to show a pictorial diagram (10) of the shop by categories of items and also to location the actual position (on shell) of a shop item.

4. The system according to claim 1 wherein a control board which comprises of the following;
A display screen (11) which shows claim 3, the list of items picked-up with the total cost and many other information like reviews of items; point of sale terminal (12) to validated and accept payment from any card; Scanning device (13) to scan the barcode on items; Receipt printer (13) to print receipts after payment;

5. The system according to claim 1, wherein the enhanced supermarket trolley comprises of the following; Highly sensitive electronic scale (14) at the base of the trolley to check and confirm the weight of items put in it and gives the feed back to control board in claim 4; An automated door (15) or cover wherein opens and closes at command from control board. It allows customers to drop items into the enhanced trolley after it has been scanned and the cost accepted; Geographical locator (16) at the under the system wherein the geographical coordinates or invisible lines on the shopping floor are used to trigger certain functions.

6. The system according to apparatus 12, will be compatible with all card system and also have it's own propriety cards. The system according to apparatus 7, has a payment module on it which is also allows as many e-money configured by the shop administrators. For customers who have physical cash, an ‘API’ will be given to cash deposit ‘ATMs’ around the mall which will take the cash and vital customer details like name, email and mobile phone number and give an e-voucher of equivalent cash. The voucher could be in various forms like a receipt with a barcode, pin and serial number and or with mobile phone number for authentication. The system will accept this voucher as e-money and allow customer to purchase items. If there is a balance from the voucher, the ‘ATM’ can be used for withdraw the remaining money. The system according to apparatus 13, 9, 15, 14,16 will automatically enforce all items picked are scanned and accepted before it is allowed into the trolley by the door. Items dropped are cross checked against the known weight. if the weight fails to match with the known weight, the light (17) around the trolley changes to red and customer is also notified on the control board with instructions on how to correct this system check. When the customer finishes shopping and is leaving the shopping area, the geographical locator triggers this information to the control board and the customer is reminded to pay either with the card or the e-voucher. if the customer pays then the light around the trolley will be green, receipt will be printed out and the top of the trolley (automated door) will be opened as long as the trolley does not return into the shopping area but continues to go outside the shop and beyond. if the customer does not comply to the instructions to pay and continues to leave the shopping area, in addition to the red light all around the trolley there will be an increasing beeping sound and the wheels of the trolley will be locked by a trigger activated from the geographical locator (16) as programed into the apparatus 7. Hence the customer cannot push the trolley or open it to take the items out. Based on the configured instructions shop personal will be alert at any point from when the initial red lights was triggered to the automatic stopping or locking of the wheels.

7. The manual operational process of the counting of physical cash against the total amounts per shop teller with it's associated processes compels shop to close whilst these tasks are been performed. The system in according to claim 6 enforce the shop operates cashless hence there will be no need to force the shop to close when these ‘end of day’ tasks are been done. This now allows the shop to operate 24 hours in a day, 7 days in a week.

8. The system creates a fully self service functions which would have been done by a shop tellers to scan all items picked by the customer, collect payment for the items and print out a receipt for the items. Therefore the number of staff who perform these functions and supporting roles can be significantly reduced.

9. The system according to claim 8, there will be no need for customers to wait on shop tellers to scan, collect payments for items and give them receipts. This waiting is the root cause of long queues in shopping halls especially during peak periods, Sales and festive seasons.
